(19) United States
(12) Patent Application Publication
(10) Pub. No.: US 2026/0328584 A1
(43) Pub. Date: Oct. 22, 2026

(54) FIELD MAPPING SYSTEM AND METHOD

(71) Applicant: Mojow Autonomous Solutions Inc., White City (CA)

(72) Inventors: Owen KINCH, White City (CA); Mojtaba HEDAYTPOUR, Edmonton (CA)

(21) Appl. No.: 18/836,642

(22) PCT Filed: Jan. 19, 2023
(86) PCT No.: PCT/CA2023/050054

§ 371 Date: Aug. 7, 2024

(51) Int. Cl. G01C 21/00; A01B 79/00; G06T 7/73

(52) U.S. Cl. CPC G01C 21/3826; G01C 21/3841; G01C 21/3852; G01C 21/3859; G06T 7/73; A01B 79/005; G06T 2200/24; G06T 2207/10032; G06T 2207/20084; G06T 2207/20092; G06T 2207/30188

(57) ABSTRACT

A farm mapping system and method to accurately locate boundaries and entrance determination for autonomous farm machinery. The mapping system includes processing structure, one or more sensor systems providing sensor data, at least one communication device, and a power platform for propelling the mapping system through the farm. The sensor system has a field of view relative to the power platform. The processing structure retrieves at least one overview map of the farm via the at least one communication device. The method includes providing sensor data to a processing structure, instructing a power platform to propel the processing structure through the farm, retrieving an overview map of the farm via a communication device, estimating an estimated field feature from the overview map, and updating a global farm map by continuously processing the sensor data.

### RELATED

The present application is a National Phase entry of PCT Application No. PCT/CA2023/050054 filed Jan. 19, 2023, which claims priority to U.S. Provisional Application No. 63/307,452, filed on Feb. 7, 2022, the contents of both being expressly incorporated by reference herein.

### FIELD

This invention is in the field of farm mapping and, in particular, to accurately locate boundaries and entrance determination for autonomous farm machinery.

### BACKGROUND

U.S. Pat. No. 9,942,440 to Kurshanskiy et al. discloses detection and identification of a field's boundaries based on processing images of the field captured at different times, relative to a defined seed point. Images are clipped to align with the seed point and a bounding box around the seed point, and a mask is built by extracting edges of the field from the images. The workflow floods an area around the seed point that has pixels of a similar color, using the mask as an initial boundary. The flooded area is compared to threshold parameter values, which are tuned to refine the identified boundary. Flooded areas in multiple images are combined, and a boundary is built based on the combined flooded set. Manual, interactive tuning of floodfill areas allows for a separate boundary detection and identification workflow or for refinement of the automatic boundary detection workflow.

U.S. Pat. No. 10,900,787 to Shinkai et al. discloses a field traveling route production system. A field information storage section stores field information including position information of a field and an entrance/exit area of the field. A work traveling route calculation section calculates a work traveling route for the field work vehicle based on the field information and specification of the field work vehicle. The work traveling route interconnects a traveling work starting point and a traveling work ending point. A fore traveling route calculation section calculates a fore traveling route extending from the entrance/exit area to the traveling work starting point of the work traveling route. A post traveling route calculation section calculates a post traveling route extending from the traveling work ending point to the entrance/exit area.

### SUMMARY

The invention may comprise one or more of any and/or all aspects described herein in any and/or all combinations.

According to an aspect, there is provided a mapping system for mapping a farm. The mapping system may comprise: a processing structure; at least one sensor system providing sensor data to the processing structure; at least one communication device; a power platform for propelling the mapping system through the farm; the at least one sensor system comprises a field of view relative to the power platform; at least one tangible computer-readable memory device storing a plurality of instructions to be executed by the processing structure; wherein the processing structure may retrieve at least one overview map of the farm via the at least one communication device. The processing structure may determine at least one estimated field feature from the at least one overview map. The processing structure may display the at least one overview map on a user interface; and may receive user inputs corresponding to drawing of at least one estimated field feature. The at least one sensor system may comprise at least one of: a magnetometer, an imaging sensor, a range sensor, a radio detection and ranging (radar), a sound navigation and ranging (sonar), inertial sensors, and a global positioning sensor.

The estimated field features may be selected from at least one of: an estimated external field boundary, an estimated internal field boundary, an estimated field entrance, and an estimated starting point location. The processing structure may detect a portion of the estimated field features within the field of view of the sensor data; may calculate a position of the portion of the estimated field features based on the sensor data; and may adjust the portion of the estimated field features to determine a calculated field feature for the portion of the estimated field features.

The processing structure may create and updates a local map of the estimated field features around the power platform using the sensor data. The processing structure may create and updates a global map of the estimated field features at the farm using the sensor data and the local map.

The processing structure may calculate the position of the portion of the estimated field features using an artificial neural network-based model. The processing structure may calculates the position of the portion of the estimated field features by determining a non-field area and a field area. The processing structure may determine at least one crop row and determines a crop row space between crop rows. The processing structure may calculate the position of the portion of the estimated field features based on the crop rows and the crop row space. The processing structure may calculate the position of the portion of the estimated field features based on a position of an attached implement and a relative position of a tip of the attached implement.

According to another aspect, there is provided a method for mapping a farm. The method may comprise: providing sensor data to a processing structure; instructing a power platform to propel the processing structure through the farm; retrieving an overview map of the farm via a communication device; estimating an estimated field feature from the overview map; and updating a global farm map by continuously processing the sensor data.

The method may detect a portion of the estimated field feature within a field of view of the sensor data; calculating a position of the portion of the estimated field feature based on the sensor data; and adjusting the portion of the estimated field features to determine a calculated field feature for the portion of the estimated field feature. The method may create and update a local map using the estimated field feature. The method may plan a path to follow a boundary. The method may store a history of the local map and changes to the estimated field feature. The estimated field feature may be selected from at least one of: an estimated external field boundary, an estimated internal field boundary, an estimated field entrance, and an estimated starting point location.

The method may calculate the position of the portion of the estimated field feature using an artificial neural network-based model. The method may calculate the position of the portion of the estimated field feature by determining a non-field area and a field area. The method may determine at least one crop row and determines a crop row space between crop rows. The method may calculate the position of the portion of the estimated field feature based on the crop rows and the crop row space. The method may calculate the position of the portion of the estimated field feature based on a geometry and a position of an attached implement and a relative position of a tip of the attached implement. The method may calculate the position of the portion of the estimated field feature based on a traveling path of the power platform.

At least one sensor system may provide sensor data and may comprise at least one of: a magnetometer, an imaging sensor, a range sensor, a radio detection and ranging (radar), a sound navigation and ranging (sonar), inertial sensors, and a global positioning sensor. The method may display the at least one overview map on a user interface; and receiving user inputs corresponding to drawing of the estimated field feature.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a perspective top view of a sensor system on a power platform;

FIG. 2 is a block diagram of an autonomous controller;

FIG. 3 is a process executing on the autonomous controller for controlling the power platform;

FIG. 4 is an example map demonstrating estimated inputs of locations and boundaries;

FIG. 5 is an example map demonstrating measured locations and boundaries;

FIG. 6 is an example map demonstrating a plurality of fields in conjunction with a road network with an example path plan from a current location of the power platform to a starting point for following and mapping a boundary and locations;

FIG. 7A is an example image for determining a field boundary and FIG. 7B is the example image following processing from a segmentation model separating a field area (dark) from non-field area (light);

FIGS. 8A and 8B are processes executing on the autonomous controller for mapping a field;

FIGS. 9A and 9B are example images demonstrating estimating of one or more field features;

FIG. 10 shows the power platform directed by the autonomous controller following and measuring a field boundary;

FIG. 11 shows the power platform following and measuring a field in presence of a temporary obstacle;

FIG. 12 shows an example image showing a measurement of a field entrance;

FIG. 13 shows an example field with estimated boundaries (shown in white) drawn thereon using a user interface and measured boundaries (shown in black);

FIG. 14 shows the power platform driving close to the field boundary with heavy harrow implement;

FIG. 15 shows an adjustment to the estimated field boundary based on a calculated boundary along a portion of the estimated field boundary;

FIG. 16 shows an example path planning between a plurality of starting points;

FIG. 17 shows a process for determining an entrance;

FIG. 18 shows an example image of the entrance determined by the process of FIG. 17; and

FIG. 19 shows an example of a sharp turn on a field boundary.

### DETAILED DESCRIPTION

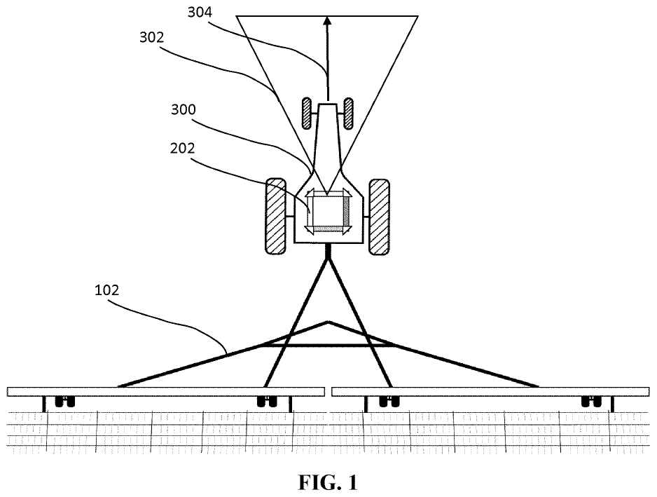

As shown in FIG. 1, a power platform 300 may provide one or more functions for a farm implement 102 such as a motive force to propel the implement in an arbitrary (e.g. forward, sideways or backward) direction, an electrical power supply, and/or a pressurized hydraulic fluid. In the aspect described herein, the power platform 300 may comprise a traditional tractor that pulls one or more implements 102 behind. In some other aspects, the power platform 300 may comprise a tractor-like vehicle that moves one or more implements from front or underneath. In some aspects, the power platform 300 may comprise one or more actuators (electric and/or hydraulic). In some other aspects, the power platform 300 may be equipped with an autonomous controller 200 with a sensor system 202.

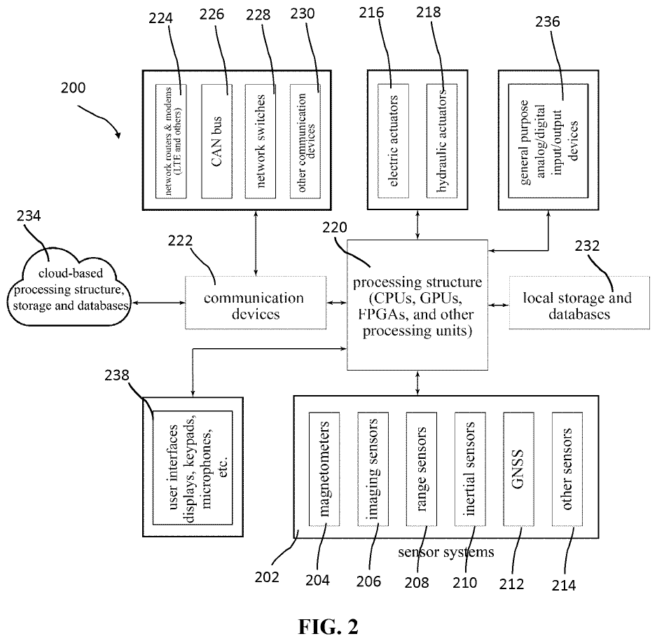

The controller 200, described in further detail with reference to FIG. 2, may be integrated with the power platform 300 to form a controller 200 for the power platform 300. In some aspects, the controller 200 may be a separate unit that may be coupled to an existing power platform 300 or in other aspects, the controller 200 may be built into the power platform 300. In even other aspects, the controller 200 may be coupled to an existing implement 102 or integrated with the implement 102. The controller 200 may provide one or more communication channels between the implement 102 and the power platform 300 where one may not have previously existed. In some aspects, the implement 102 may not have an electronic control unit (ECU). In some aspects, the controller 200 and/or parts of its software and/or hardware may be hosted in the cloud.

The controller 200 may comprise one or more sensor systems 202. The one or more sensor systems 202 may comprise one or more sensors, such as magnetometers 204, imaging sensors 206 (e.g. cameras), range sensors 208 (e.g. light detection and ranging (LiDAR), radio detection and ranging (radar), sound navigation and ranging (sonar)), inertial sensors 210 (inertial measurement unit (IMU)), GNSS/GPS 212, and/or other sensors 214 (e.g. microphones, digital switches, and/or analog potentiometers). In this aspect, one or more imaging sensors 206 (e.g. cameras), or other directional sensors, may have a field of view 302 looking towards a direction of travel 304 or a power platform path. Other aspects may have fields of view 302 looking in other directions.

In this aspect, the sensor system 202 may be mounted on a roof of the power platform 300. The location of the sensor system 202 is merely an example. Other aspects may have the sensor system 202 located anywhere on the implement 102 or the power platform 300 as long as the field of view 302 is not substantially obstructed. Other aspects may have the sensor system 202 mounted on another mobile vehicle, such as an aerial vehicle and/or a ground vehicle, that may be temporarily detached from the power platform 300 and/or the implement 102. The sensors in the sensor system 202 may be calibrated and/or one or more intrinsic and/or extrinsic parameters may be known.

The sensor systems 202 may provide sensor data to a processing structure 220. In some aspects, the controller 200 may be the same as the processing structure 220. The processing structure 220 may comprise one or more of: a digital signal processor (DSP), an artificial neural network, a graphics processing unit (GPU), a Field Programmable Gate Arrays (FPGA), and/or a combination thereof. The processing structure 220 may comprise a processor (single or multicore) and associated support circuitry (e.g. clock, etc.). In some aspects, the controller 200 may comprise one or more communication devices 222 such as network routers 224 with LTE, 3G, 4G and 5G support, CAN bus 226, network switches 228, and/or other communication devices 230. The processing structure 220 may also have one or more general purpose input/output ports 236 that may be digital or analog. The processing structure 220 may control one or more flow control valves, electric actuators 216 and/or hydraulic actuators 218. The processing structure 220 may display a user interface 238 on a display and/or speak to a user through a speaker or headphone and may accept user input via a touch system, keypads, microphones, etc. The user interface 238 may be located local to the controller 200 or may be provided at a remote location, such as through a website.

In some aspects, the controller 200 may comprise one or more tangible computer-readable storage and memory devices 232, such as one or more database systems, to store and manage sensor data. The one or more storage and memory devices 232 may store a plurality of instructions for execution by the processing structure 220 as described in more detail herein. The one or more database systems may be hosted in a cloud-based storage and database 234. In some aspects, one or more portions of the processing structure 220 may be hosted in a cloud-based processing structure 234.

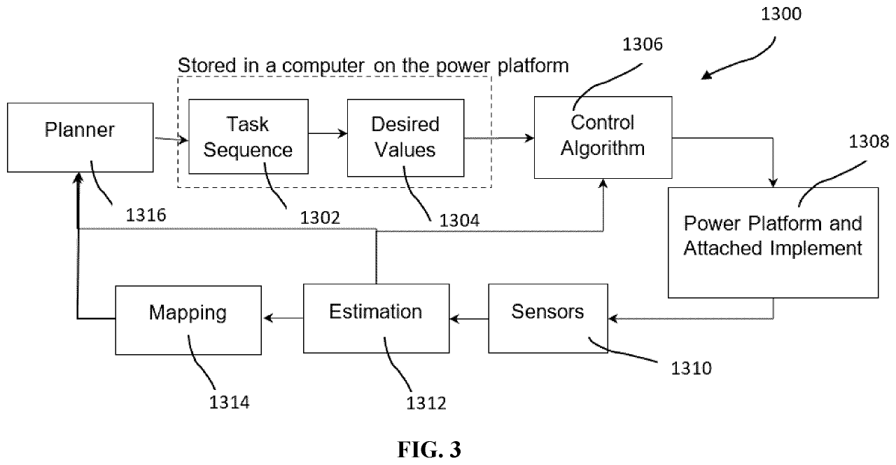

Turning to FIG. 3, the processing structure 220 may instruct the power platform 300 to travel along a trajectory generated by a planner 1302 (for example, travel forward in a straight line, such as 200-feet). Alternatively, the processing structure 220 may continually process image and other sensor data from the cameras and other sensors during the travel along the planned trajectory. If obstacles are detected, then the autonomous power platform 300 may travel along a trajectory generated by the planner 1302 (for example, travel forward in a straight line, such as 200-feet) to avoid the obstacle. The processing structure 220 may then instruct the power platform 300 to continue the motion with slight steering adjustments based on the inputs from the planner 1302 and/or from the processing structure 220. The processing structure 220 may process the image and/or other sensor data using one or more computer vision (CV) and artificial intelligence (AI) techniques, as described in further detail below.

When the processing structure 220 detects a deviation of any of the control steps and/or positions and/or angles, the processing structure 220 may indicate a fault on the user interface 238, stored in a log file, or in some aspects, the autonomous controller 200 may perform corrective action itself, store the fault in the database 234 and halt movement of the power platform 300. An example of a corrective action may be stopping the power platform 300 or halting movement of the power platform 300.

A planner block/process 1302 may receive one or more of the control parameters and variables and map data, the map data from the mapping block 1314 and the estimation of parameters and variables from the estimation block/process 1312. Various planning tasks may be computed in this block. For tasks related to the motion of the power platform 300 and the implement, the planner block 1316 may generate a trajectory for the power platform 300 to follow.

The mapping block/process 1314 may receive the estimation of parameters and variables from the estimation block 1312 and generate a local map of the estimated features from the data from the sensors 202. The local map may be 2-dimensional or 3-dimensional. In some aspects the map may have higher dimensions representing other measurements associated with the data from the sensors 202 such as moisture, crop population, etc. In some aspects the local map may be an occupancy grid map used for navigation tasks. In some other aspects the map may be a 2-dimensional representation of the area around the power platform 300. The mapping block 1314 may generate a global map of the farm based on all the local maps generated during the motion of the power platform 300.

The global map may be a 2-dimensional or 3-dimensional representation of the farm including the farm fields, entrances, roads, farm yard and any other area where the power platform 300 may travel to. In some aspects the global map is stored onboard the processing structure on the power platform 300. In some other aspects the global map may be stored on a remote processing structure that is accessible from the processing structure onboard the power platform 300.

These blocks 1316, 1302 may receive the initial states from inputs from the Estimation block 1312 and mapping data from the mapping block 1314. The planner block 1316 may plan one or more trajectories for the power platform 300 to travel along the estimated features in the map from the mapping block 1314. In some aspects, the planner block 1316 generates a trajectory for the power platform 300 to travel along the estimated boundaries with a certain offset generally determined by the attached implement width. In some other aspects the planner block 1316 generates a trajectory for the power platform 300 to enter/exit a field through the estimated entrance boundaries. In some other aspects, the planner block 1316 generates a trajectory for the power platform to avoid a detected obstacle along the traveling path of the power platform 300. The task sequence block 1302 may use this initial state data to determine when a task is finished and/or when a new task may need to be sent to the control block 1306. A control block/process 1306 may comprise a variety of control methods that may depend on one or more requirements of the power platform 300 and/or the implement 102.

For each task from the task sequence block/process 1302, the task may be selected and the desired values of the states may be determined in the desired values block 1304. These desired values for the states of the power platform 300 and/or the attached implement 102 may then be sent to the control block 1306. Depending on the selected task, certain control methods, such as Proportional-Derivative-Integral (PID), Model Predictive Control (MPC), linear or nonlinear control algorithms, may be used to determine the values for manipulated variables. In some aspects, reinforcement learning and/or end-to-end deep learning methods may be used to determine the values for manipulated variables. These manipulated variables may be sent to the power platform 300 as input commands.

A sensor block/process 1310 may comprise one or more sensors 202 configured to measure the parameters and variables of the power platform 300 and/or the implement 102. The sensors 202 may comprise one or more of the following: cameras (RGB cameras in stereo configuration, monochrome cameras, depth cameras, multispectral and hyper-spectral cameras, etc.), GPS, light detection and ranging (LiDAR), radio detection and ranging (Radar), sound navigation and ranging (Sonar), inertial measurement unit (IMU), microphones, optical and/or magnetic encoders, and magnetometer as well as digital switches and analog potentiometers.

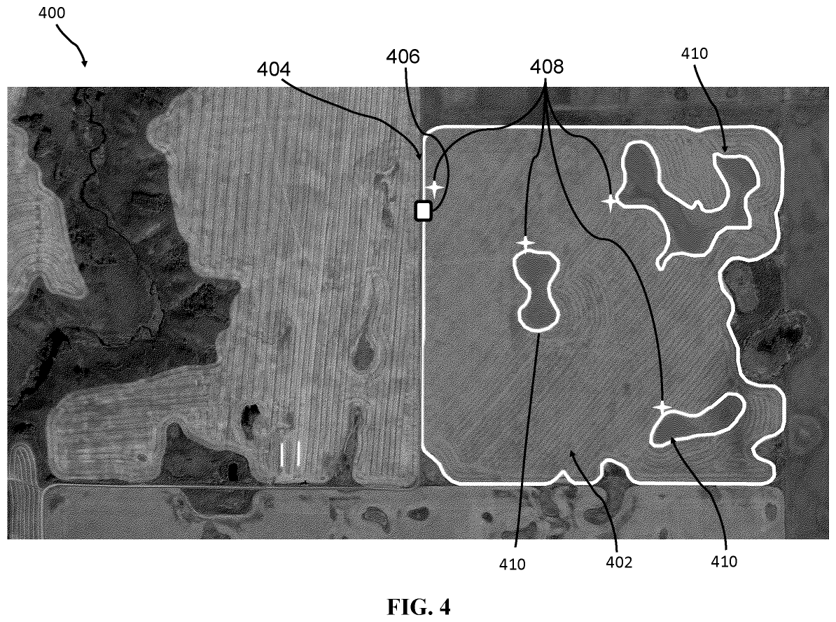

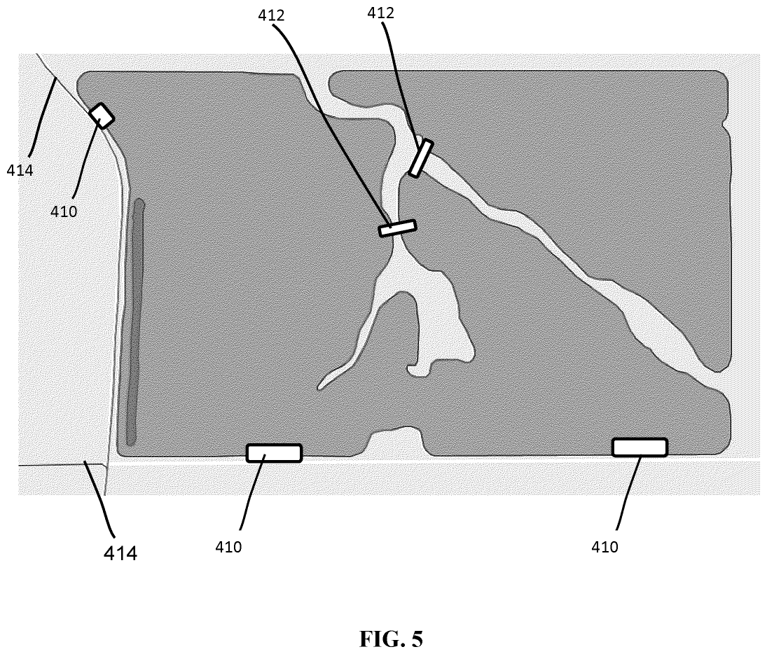

Turning to FIGS. 4 and 5, the processing structure 220 may retrieve and display one or more satellite and/or aerial maps 400 (e.g. overview maps) on the user interface 238. The processing structure 220 may select a location of the satellite maps 400 via user input and/or retrieving GPS coordinates from the GPS 212. The location may correspond to a farm or field maps 402. In some other aspects, a human operator may drive the power platform 300 along the boundaries wherein the sensor system 202 records data continuously so the processing structure 220 may create an initial map 400 based on the recorded data.

According to an aspect, the user interface 238 may accept user inputs on the satellite map 400 from a mouse, keyboard, microphone, pen, and/or a touch screen. The user inputs may correspond to drawing one or more estimated field features, such as one or more estimated external field boundaries 404, one or more estimated internal field boundaries 410, one or more estimated field entrance areas 406, and/or one or more estimated starting point locations 408. In other aspects, the user may input other locations of interest, such as one or more transition area locations 412, one or more roads 414, farmyards, and/or farmyard entrances as well as any other designated area by drawing the boundaries of those areas. The drawings may be in any form, such as points, lines, circles, polylines, and/or polygons and/or may be in two-dimensions or three dimensional Cartesian frame of reference.

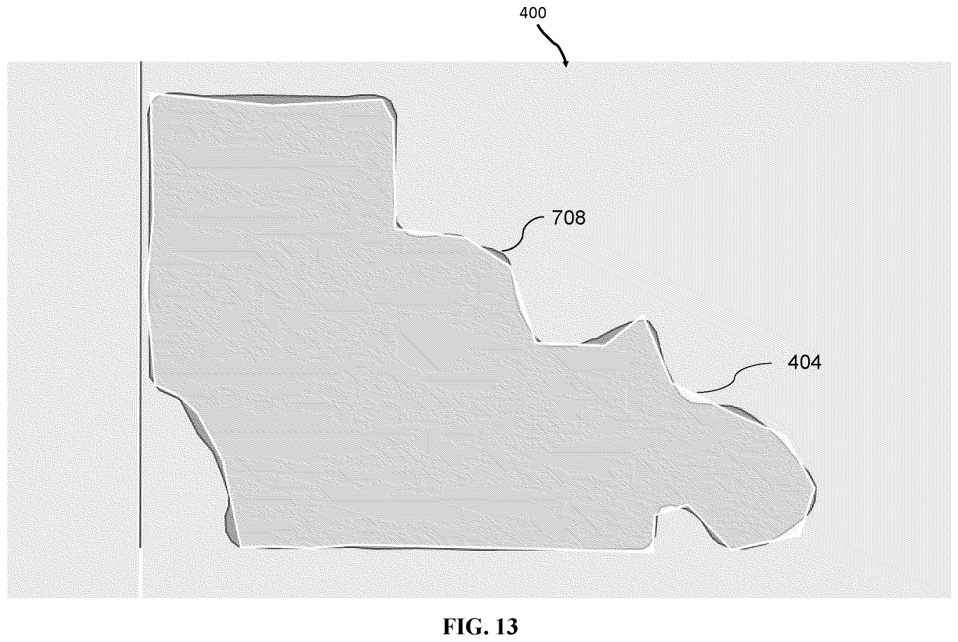

According to an aspect, the estimated external field boundaries 404, the estimated internal field boundaries 410, the estimated field entrance areas 406, and/or the estimated starting point locations 408 may be calculated based on the satellite map 400 using computer vision techniques. In this process, the user may initially draw the boundaries 404 using the provided interface such as the white boundaries shown in FIG. 13. The drawn boundaries 404 may be used as the starting point for a boundary refinement process. Using computer vision techniques, a search process around the drawn boundaries 404 on the satellite imagery 400 may refine the boundaries 404 into refined boundaries 708 in FIG. 13. The search process for refining the boundaries may use any of the computer vision techniques such as edge detection, image feature detection, and/or deep learning-based methods. In some aspects, a segmentation deep learning model may be trained on a plurality of annotated images to identify pixels in the satellite image 400 that are part of the field boundary 708. The satellite images 400 may be annotated by expert humans and the annotations may include the boundaries 708. The estimated field features may then be presented on the user interface 238. The user interface 238 may permit adjustment to the estimated field features determined by calculation from the satellite map 400. In some aspects, the roads 414 may be retrieved from an existing map service, such as Google Maps, Mapbox Maps, and/or the like.

The estimated field features 404, 406, 408, 410, 412 may each be given one or more corresponding pixel locations in an image coordinate frame of the satellite map 400. The processing structure 220 may transform the pixel locations into a corresponding latitude, longitude, and/or altitude for each of the estimated field features 404, 406, 408, 410, 412 based on a transformation provided by a satellite image provider.

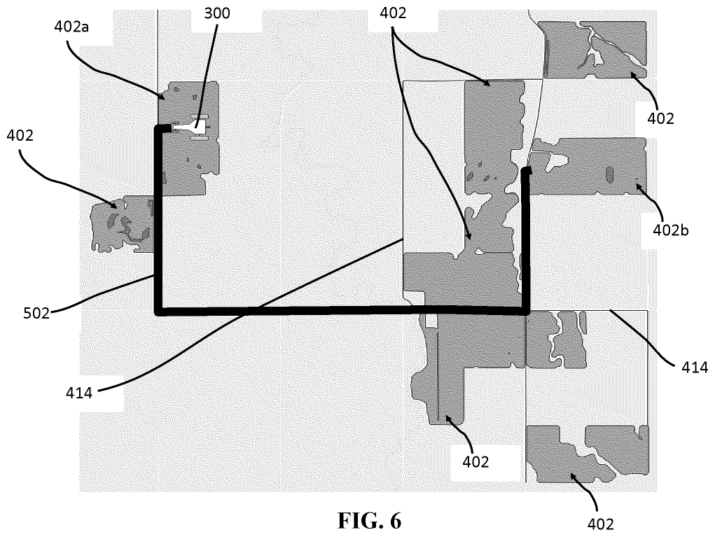

Turning to FIG. 6, one or more field maps 402 may be grouped together and associated with one farmer or farming corporation and each of the field maps 402 may comprise the one or more estimated field features 404, 406, 408, 410, 412. The processing structure 220 may calculate one or more paths 502 to and/or from each of the field maps 402. For example, the processing structure 220 may calculate the path 502 for the power platform 300 from field map 402a to field map 402b along one or more roads 414. In another aspect, the user may input the path 502 between each of the field maps 402.

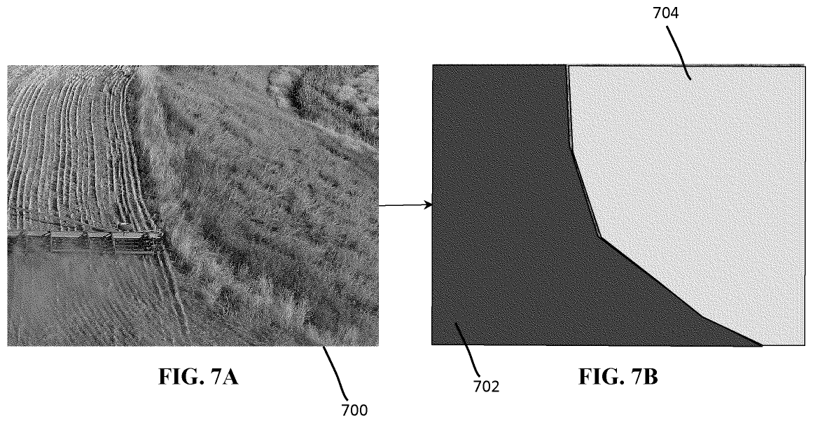

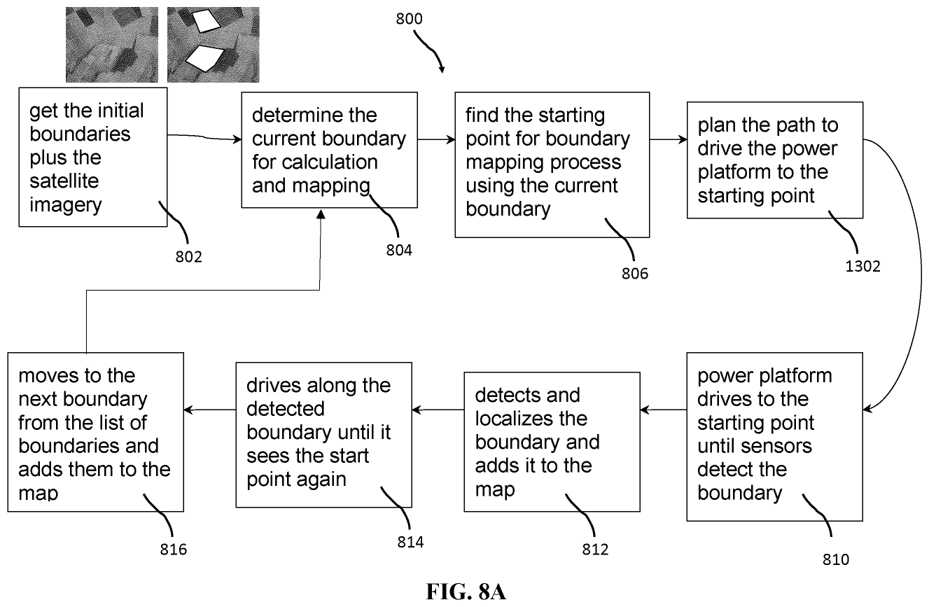

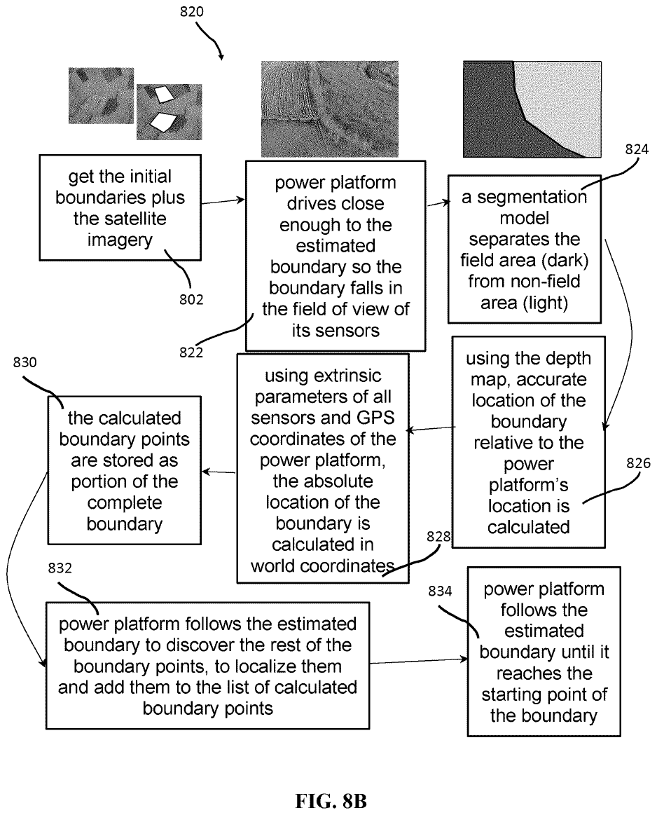

FIGS. 8A and 8B show processes 800, 820 executing on the processing structure 220 for mapping the estimated field features 404, 406, 408, 410, 412 onto one or more images 700, such as shown in the example images of FIGS. 7A, 9A, 9B, 12, and 18, captured from the imaging sensors 206. The process 800 may begin at a retrieval process 802 by retrieving the estimated boundaries 404, 410 from the cloud-based storage 234. The processing structure 220 may then execute a determination process 804 for determining a current boundary 404, 410 for calculating and mapping.

The processing structure 220 may determine a starting point location 408 for the current boundary 404, 410. A path planning process 1316 as previously described may plan a path to drive the power platform 300 to the starting point 408. The processing structure 220 may continue a monitor process 810 of the sensors 202 as the power platform 300 approaches the starting point 408 until the sensors 202 detect the current boundary 404, 410. When the processing structure 220 detects the boundary 404, 410, the processing structure 220 may perform an adjust process 812 in order to add the boundary 404, 410 location as described in further detail below. The processing structure 220 may then perform a following process 814 directing the power platform 300 along the detected boundary until the processing structure 220 detects the starting point 408. The processing structure 220 may then perform a selection process 816 to select a next boundary 404, 410 from the list of field features 404, 406, 408, 410, 412. The process 800 may then return to the determination process 804.

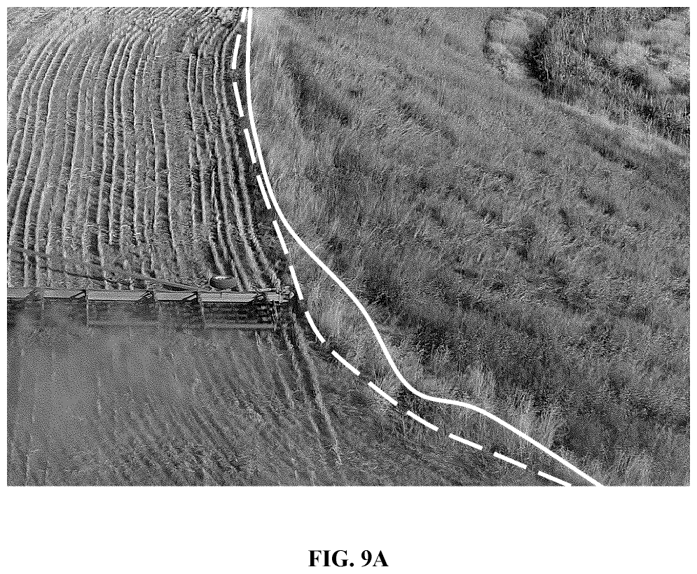

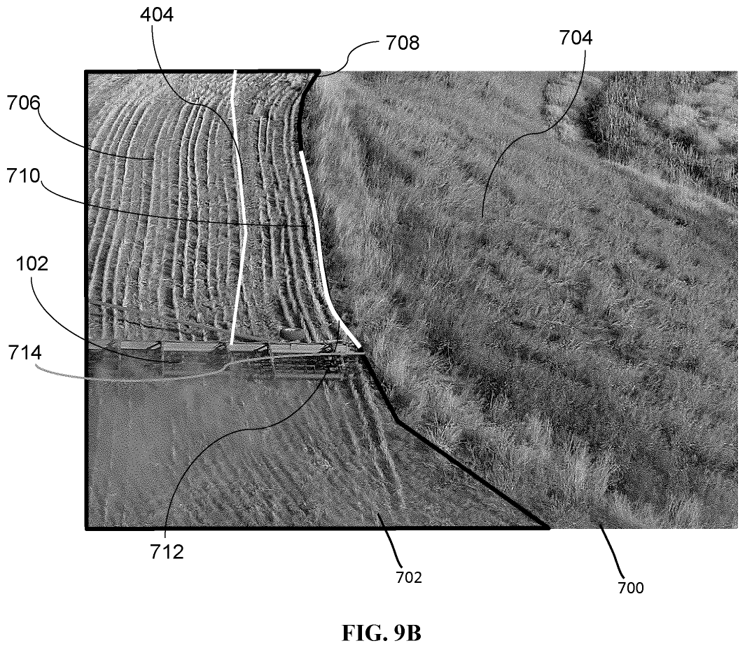

As shown in more detail in FIG. 8B, the process 820 may begin at the retrieval process 802 as previously described. The processing structure 220 may direct the power platform 300 to arrive at or near a starting point 408 close to the estimated field boundary 404 at step 822. The estimated field boundary 404 may be detected within the field of view 302. In some aspects, the processing structure 220 may present the images 700 on the user interface 238. The processing structure 220 may overlay the estimated field boundary 404 or other estimated field features 404, 406, 408, 410, 412 on the images 700 as seen more clearly in FIGS. 9A and 9B. In this example, only the estimated field boundary 404 is provided but similar processes may equally apply to the other estimated field features 404, 406, 408, 410, 412.

The processing structure 220 may execute a field determination process 824 on the images 700 to determine a field area 702 and a non-field area 704, shown particularly in FIGS. 7A and 7B. The field determination process 824 may then determine the non-field area 704 based on an irregular pattern of vegetation. In this aspect, the field area 702 and the non-field area 704 may be determined using a segmentation process or model 824. The segmentation process 824 may comprise a segmentation deep learning model that may be previously trained on a plurality of previously annotated images of boundaries. In some aspects, an instance segmentation may be used. In other aspects, a semantic segmentation may be used. In some other aspects data from range sensors (e.g., Lidar) may be used to determine the field area and non-field area.

The segmentation deep learning model 824 may be an artificial neural network-based model that may be trained on a plurality of annotated images of farm fields and different boundaries in farm fields. The images may be collected from farm fields for different crops and in different field conditions (e.g., rainy day, sunny day, cloudy day, etc.) and may be annotated by expert human annotators using appropriate user interfaces. The annotations on the images 700 include accurately drawn boundaries, field area, non-field area, sky, crop rows, types of crops and any other necessary information an expert human uses to determine field area. The annotated data may be used to train the segmentation deep learning model 824. The trained segmentation model 824 may accept sensor data (e.g., images) as input and determines the field area and non-field area of the input data. In some aspects, data from multiple sensors is used for training the segmentation model 824.

The semantic segmentation may process the sensor data provided by the one or more sensors 202. For example, a depth map process 826 may also be calculated in real-time using the range sensors 208 in order to further improve the segmentation process 824 based solely on images 700, such as shown in FIG. 9A. As may be observed from FIG. 9B, the calculated boundary 708 is more accurate than the previous boundary 404, 410. Using the sensors' data, the depth map and location of the power platform 300, the calculated boundary 708 may be localized 828 using one or more extrinsic parameters of the sensors 202, the GPS coordinates of the power platform 300. The calculated boundary 708 may be stored as a portion of the boundary on the field map 402. The processing structure 220 may direct the power platform 300 to follow the estimated boundary 404, 410 at step 832 to measure the rest of the boundary 404, 410 until the processing structure 220 determines when the power platform 300 reaches the starting point at step 834 or at any other point determined by the processing structure to stop or pause the mapping process. In some aspects the mapping process may be done in multiple steps and the field boundary may be broken down in one or more segments where the combination of all the segments forms a complete field boundary.

The one or more crop rows 706 may be determined with a crop row detection system or process comprising the sensors 202, such as the range sensors 208. A spacing 808 between the crop rows 706 may be measured using the crop row detection system or process. Once the spacing 808 between the crop rows 706 has been determined, any distance measurements and/or localization may be based relative to multiple of the crop row spacing 808. In some other aspects, the processing structure 220 may execute a computer vision process to identify the crop rows 706 and/or may determine the spacing 808 based on known lengths present in the images 700 (e.g. such as the width of the implement 102 and/or the power platform 300). In some other aspects, the crop row spacing is known and provided by the user.

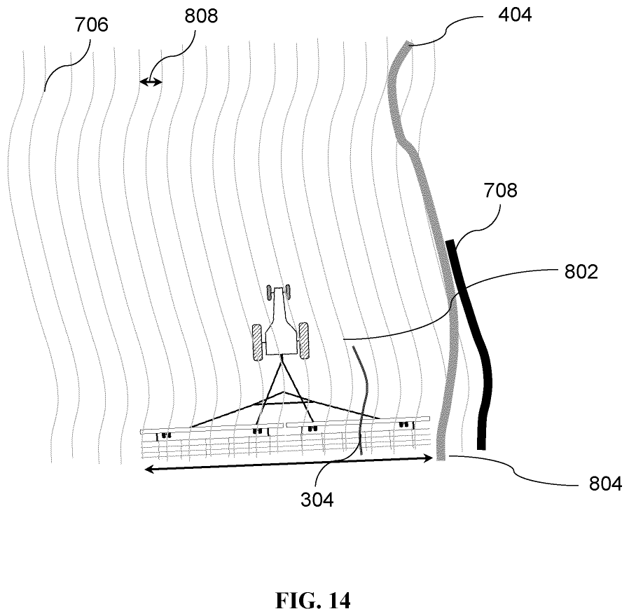

In some aspects, an implement width 804 may be incorporated into the determination of the calculated boundary 708 by using the current location of the power platform 300, one or more kinematics equations of the power platform 300, the implement width 804, an orientation of the power platform 300 and/or an orientation of the implement 102, and the last detected crop row. For example, FIG. 14, shows the power platform 300 driving close to the field boundary 404 with heavy harrow implement 102. The width of the heavy harrow implement 102 may be known (e.g., 70-ft) and the crop row spacing may also be known (e.g., 15-in). The tip of the heavy harrow implement 102 may only be two crop rows away from the field boundary 708 determined by the segmentation deep learning model 824. Therefore, using the relative orientation between the power platform 300 and the implement 102, known implement width, known crop row spacing, and the result of the segmentation deep learning model 324, a location of the field boundary 708 may be determined. In some other aspects, only the crop rows are used to determine the location of the field boundary by counting the number of detected crop rows. In some other aspects only the crop rows and implement are used to determine the estimated boundaries.

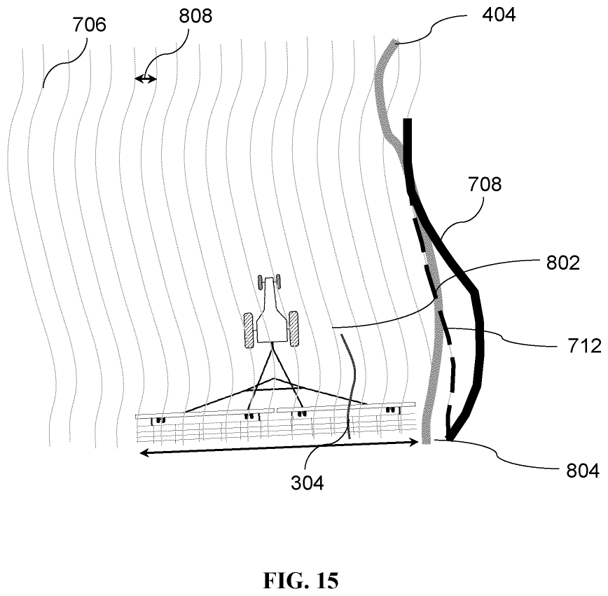

The processing structure 220 may then perform an adjustment process 830, as shown visually in FIG. 15, to adjust the estimated field boundary 404 based on the calculated boundary 708 along a portion 712 of the estimated field boundary 404 visible in the image 700. In some aspects, a last crop row 710 from the one or more rows 706 may be determined and may be used to determine the calculated boundary 708 and/or further refine the calculated boundary 708 as shown in FIG. 15. In some aspects, the detected boundaries 708 may be compared with the estimated boundaries 404 and any discrepancies may be reported to the human operator on the user interface 238 for resolving any differences. The human operator may also draw the boundary on the user interface 238 to help the processing structure navigate where field boundary features are not present and/or are not detected by the processing structure.

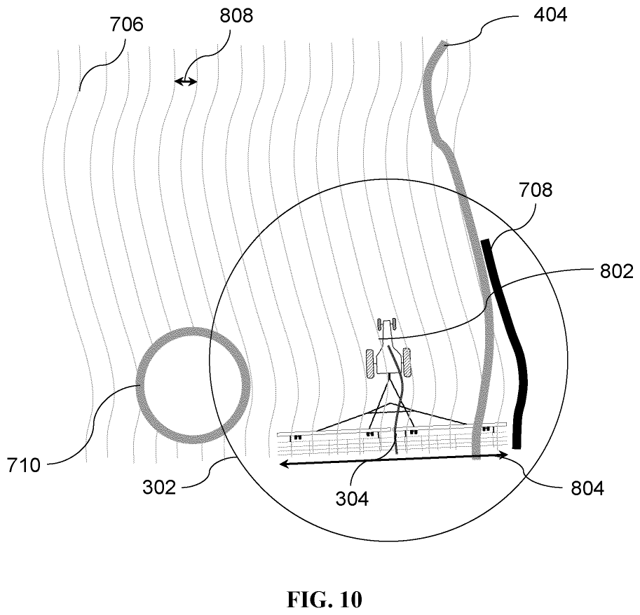

In some other aspects, a travel row 802, shown more clearly in FIG. 10, may be determined based on the travel path 304 of the power platform 300 and in combination with a width of the implement 102 may be used to determine the calculated boundary 708 and/or further refine the calculated boundary. In yet another aspect, an end 714 of the implement 102 may be determined and used to determine the calculated boundary 708 and/or further refine the calculated boundary 708 as previously described. In this aspect, once the end/tip of the implement 102 reaches the last detected crop row, the end/tip point is determined as the location of the field boundary.

Once the field features 404, 406, 408, 410, 412 have been calculated, each of these field features 404, 406, 408, 410, 412 may be stored as one or more shapes and/or points in the defined frame of reference for the field. These shapes may comprise one or more points or may be vector representations of the shapes. In some aspects, the field features 404, 406, 408, 410, 412 may also comprise partial or full 3D point cloud representation of the feature 404, 406, 408, 410, 412. In some other aspects, the field features 404, 406, 408, 410, 412 may comprise 2D point images features and/or image key frames. In some other aspects, the feature 404, 406, 408, 410, 412 may comprise 3D point cloud and/or 2D point image features of specific landmarks in the field such as power poles, posts, buildings, etc. The field features 404, 406, 408, 410, 412 may then be stored on one or more storage and/or memory devices 232. The autonomous controller 200 may access one or more of the farm maps from the storage 232. In some aspects, a history of the field features 404, 406, 408, 410, 412 may be stored and/or transferred to the cloud-based storage 234 via the communication devices 222. In a further aspect, the processing structure 220 may perform a comparison between each of the field features 404, 406, 408, 410, 412 to the history of the field features 404, 406, 408, 410, 412 and update the shape and/or location of the field features 404, 406, 408, 410, 412. This history of the field features 404, 406, 408, 410, 412 may be retained partially or completely. In some aspects, the processing structure 220 may provide this history on the user interface 238 allowing a human operator to browse through the history for each field feature 404, 406, 408, 410, 412 in the map. In some other aspects, the human operator may add field features 404, 406, 408, 410, 412 to the map manually using the drawing tools in the user interface 238.

Turning to FIG. 10, the processing structure 220 may determine a travel row 802 associated with the GPS coordinates from the GPS 212 of the power platform 300. The travel row 802 may be determined based on the travel path 304 of the power platform 300. The power platform 300 may follow the travel row 802, which may be updated based on the determination of the calculated boundary 708. The processing structure 220 may determine the travel row 802 based on half of an implement width 804 from the calculated boundary 708. In the event that the processing structure 220 is unable to determine the calculated boundary 708, the processing structure 220 may retrieve and follow the estimated field boundary 404 until such time that the calculated boundary 708 may be determined. In some aspects, the processing structure 220 may determine when the implement 804 is able to pass between the exterior field boundary 708 and the interior field boundary 710 and/or how many crop rows may be remaining based on a crop row spacing 808.

Although the aspect in FIG. 1 shows the field of view 302 in front of the power platform 300. The aspect shown in FIG. 9 demonstrates that the field of view 302 may encompass the power platform 300.

As the power platform 300 traverses the field map 402, the processing structure 220 may continually or periodically execute the processes 600 to update the field features 404, 406, 408, 410, 412. If multiple boundaries 708 may be detected in the field of view 302, the processing structure 220 may determine which of the multiple boundaries 708 is closest to the previously detected boundary 708. The closest boundary 708 may be selected to maintain continuity of the previously detected boundary 708. In some other aspects, when multiple boundaries 708 may be detected in the field of view 302, the processing structure 220 may calculate all the boundaries 708 seen in the field of view 302 and store them on the autonomous controller storage device.

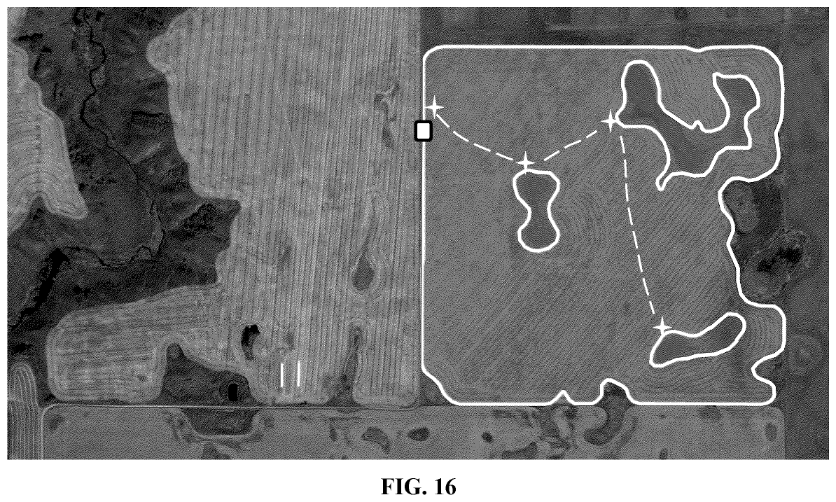

Once the power platform 300 completes following, calculating, and localizing the previous boundary 708 from a set of estimated boundaries 404, the processing structure 220 may select a next estimated boundary 404 to follow. In some aspects, the processing structure 220 may calculate a closest estimated boundary 404 to a current location of the power platform 300 and may select the closest estimated boundary 404. In some other aspects, the processing structure 220 may select the next estimated boundary 404 based on an order given for the initial set of boundaries 404. Once the next boundary 404 is determined, a starting point may be selected by the processing structure 220. In some aspects, the starting point may be a random location from the next estimated boundary 404. In some other aspects, the processing structure 220 may determine a closest point on the next estimated boundary 404 from the power platform 300 and may select the closest point as the starting point. In some other aspects, the processing structure 220 may determine the closest point that falls in the field of view 302 and may select this closest point as the starting point such as shown in FIG. 16 where each starting point may be linked to the next closest starting point as demonstrated.

Once the starting point of the next boundary is determined, the processing structure 220 may instruct the power platform 300 towards the starting point using a path planned by the path planning module 1316. The processing structure 220 may avoid any obstacles as the power platform 300 travels along the path. In some aspects, the path may be a straight line connecting the current location of the power platform 300 to the starting point of the next boundary 404. In some other aspects, the path planning module 1302 may plan an obstacle free path connecting the current location of the power platform 300 to the starting point of the next boundary 404. Once the power platform 300 reaches the starting point, the processing structure 220 may follow, calculate, and localize the boundary 404 as previously described until the power platform 300 returns to the starting point.

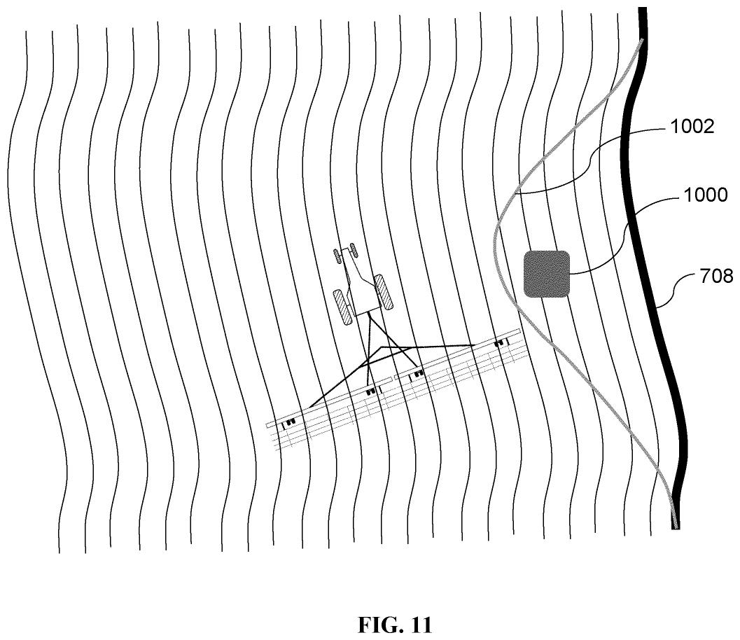

Turning to FIG. 11, an obstacle 1000 may be any non-traversable area for the power platform 300 and/or the implement 102. As part of the autonomous controller 200, an obstacle detection, localization and avoidance module may prevent the power platform 300 from stopping operation as previously described by planning a trajectory avoiding obstacles. When the processing structure 220 instructs the power platform 300 to avoid the obstacle 1000 close to the boundary 708, both the calculated boundary 708 and a modified boundary 1002 derived from the obstacle avoidance path determined by the obstacle avoidance module may be added to the map 402. In some aspects, the obstacle 1000 may be temporary such as a car, a downed tree or an animal. In some other aspects, the obstacle 1000 may be permanent such as telephone posts or power poles. In some other aspects, the processing structure 220 may display the obstacle on the user interface 238 so that the user may adjust the boundaries 708 using the user interface 238 after inspecting the boundaries 708. In some other aspects, the modified boundary 1002 may be selected by the processing structure 220 as the calculated boundary 708.

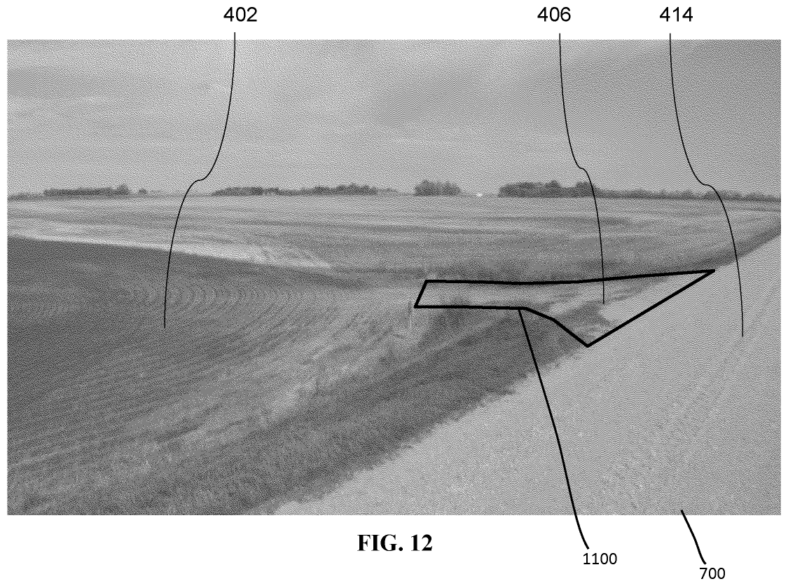

With reference to FIGS. 12, 17, and 18, an example field entrance 406 of FIG. 12 is shown in one of the images 700. As may be seen, the field 402 may be distinct from the road 414. Many fields 402 have designated areas for entering and/or exiting fields 402, known as entrances 406. Also within the fields 402 may be transition areas 412 connecting two or more fields 402 or two or more areas of a single field 402 particularly shown in FIG. 4 as previously described.

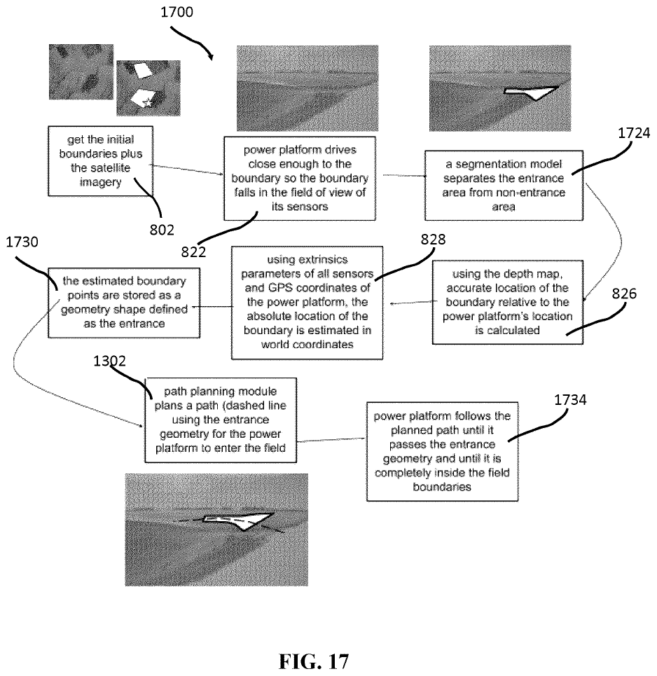

The processing structure 220 may execute an entrance determining system 1700, shown particularly in FIG. 17, comprising a number of similar steps as previously described and numbered and not described further. An entrance segmentation model 1724 may detect, calculate, and/or localize a geometry 1100 of the field entrances 406 and/or transition areas 412. The entrance segmentation model 1724 may be an object detection system trained on a large number of sample field entrances 406 and/or transition areas 412 from sensor data provided by the sensor systems 202 and annotated by experts. One or more annotations may include an accurate geometry 1100 of the field entrances 406 and/or transition areas 412 within the sensor data. In some aspects, a deep learning model 1724 may be trained on a training dataset to learn to accurately identify the field entrances 406 and/or transition areas 412 look like. In some aspects, a instance segmentation deep learning model 1724 may be incorporated into the entrance determining system 1700 to find the geometry 1100 in a data frame from the sensor systems 202. In some other aspects, the geometry 1100 may be localized using the depth map around the power platform 300 by determining the traversable area around the power platform 300.

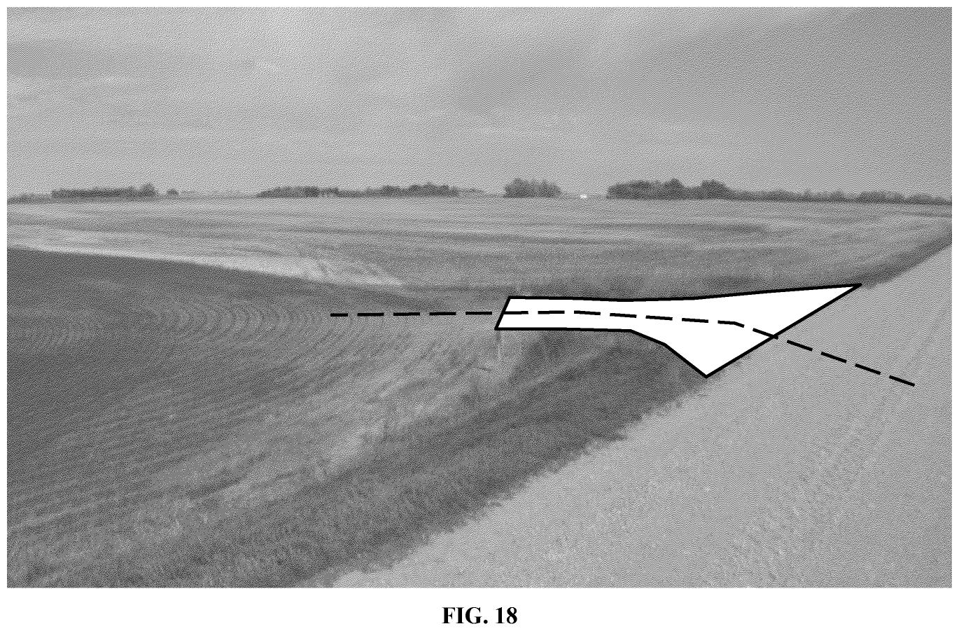

As the power platform 300 approaches one of the estimated field entrance areas 406 previously indicated by the user. The entrance determining system 1700 may be initiated to determine the geometry of the field entrance 406. A path planning module 1316 plans a path for the power platform 300 using the boundaries of the field entrance as shown in FIG. 18. The power platform follows the planned path to enter the field. A similar approach may be used to determine the boundaries of transition areas 412 within farm fields.

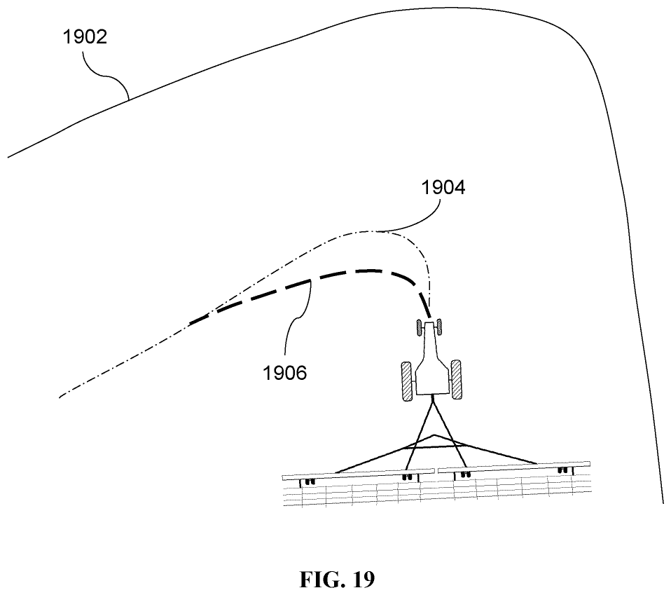

In some aspects such as shown in FIG. 19, when following any of the boundaries described herein and depending on a type of the implement 102 and width attached to the power platform 300, the power platform 300 may have to turn and travel along a path with larger curvature (e.g. a sharp corner) 1902 than a normal path. The power platform 300 may drive on with that specific implement 102. Following the corner of the field boundary around the larger curvature 1902 with the implement width may require the power platform 300 to travel on a power platform path 1904 with a larger curvature to prevent a tip of the implement 102 from leaving the field boundary. In this case, an implement path 1906 may not necessarily follow a maximum allowed curvature. For implements 102, such as a seeder and/or similar implements 102, when power platform 300 is travelling along the path with the larger curvature, the implement 102 may not operate until a portion of the path with larger curvature is passed.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A mapping system for mapping a farm, the mapping system comprising:
a processing structure;
at least one sensor system providing sensor data to the processing structure;
at least one communication device;
a power platform for propelling the mapping system through the farm;
the at least one sensor system comprises a field of view relative to the power platform;
at least one tangible computer-readable memory device storing a plurality of instructions to be executed by the processing structure;
wherein the processing structure retrieves at least one overview map of the farm via the at least one communication device.

2. The mapping system according to claim 1, wherein the processing structure determines at least one estimated field feature from the at least one overview map.

3. The mapping system according to claim 1, wherein the processing structure displays the at least one overview map on a user interface; and receives user inputs corresponding to drawing of at least one estimated field feature.

4. The mapping system according to claim 2 and 3, wherein the estimated field features are selected from at least one of: an estimated external field boundary, an estimated internal field boundary, an estimated field entrance, and an estimated starting point location.

5. The mapping system according to claim 4, wherein the processing structure detects a portion of the estimated field features within the field of view of the sensor data; calculates a position of the portion of the estimated field features based on the sensor data; and adjusts the portion of the estimated field features to determine a calculated field feature for the portion of the estimated field features.

6. The mapping system according to claim 4, wherein the processing structure creates and updates a local map of the estimated field features around the power platform using the sensor data.

7. The mapping system according to claim 6, wherein the processing structure creates and updates a global map of the estimated field features at the farm using the sensor data and the local map.

8. The mapping system according to claim 5, wherein the processing structure calculates the position of the portion of the estimated field features using an artificial neural network-based model.

9. The mapping system according to claim 5, wherein the processing structure calculates the position of the portion of the estimated field features by determining a non-field area and a field area.

10. The mapping system according to claim 5, wherein the processing structure determines at least one crop row and determines a crop row space between crop rows.

11. The mapping system according to claim 10, wherein the processing structure calculates the position of the portion of the estimated field features based on the crop rows and the crop row space.

12. The mapping system according to claim 5, wherein the processing structure calculates the position of the portion of the estimated field features based on a position of an attached implement and a relative position of a tip of the attached implement.

13. The mapping system according to claim 1, wherein the at least one sensor system comprises at least one of: a magnetometer, an imaging sensor, a range sensor, a radio detection and ranging (radar), a sound navigation and ranging (sonar), inertial sensors, and a global positioning sensor.

14-27. (canceled)

28. The mapping system according to 3, wherein the estimated field features are selected from at least one of: an estimated external field boundary, an estimated internal field boundary, an estimated field entrance, and an estimated starting point location.
